(19) United States
(12) Patent Application Publication
(10) Pub. No.: US 2007/0252052 A1
(43) Pub. Date: Nov. 1, 2007

(54) Structural improvement for chair leg

(76) Inventor: Shun Zhang Hou, Tainan City (TW)

Correspondence Address: Shun Zhang Hou, No.2, Alley 492, Hai Tien Rd. Sec.2, Tainan City, TW

(21) Appl. No.: 11/412,080

(22) Filed: Apr. 27, 2006

(51) Int. Cl. F16M 11/16

(52) U.S. Cl. 248/188

(57) ABSTRACT

The invention relates a structure improvement chair's legs. Basically, it opens several holes which have uniform distances and angles at appropriate locations on the outer bushing, holes with coordinated angles in the chair leg-supporting framework, insert the ends of the chair leg-supporting framework into the holes and fasten. Then weld the inner ring surface of the outer bushing and insert an inner bushing into an outer bushing. This achieves ease of the product's operation, durability, quality, efficiency, as well as high aesthetic value.

### FIELD OF THE INVENTION

This creation primarily inserts the two ends of chair leg-supporting framework into the outer bushing, and welds to the inner ring surface of the outer bushing. Then an inner bushing is inserted into the outer bushing. This would achieve usability, durability, quality, efficiency, as well as high aesthetic value.

### BACKGROUND

Usually, chair legs are as those in FIG. 1 and FIG. 2. The structure directly welds the chair leg-supporting framework (1) on the outer ring surface (12) of the bushing (11), then setting the chair leg structure on the chair axle (15). However, this structure produces the following problems:
1: Difficulty in welding, because the outer ring surface (12) of the bushing is curved, but the welding end (13) of the chair leg-supporting framework (1) is flat (as shown in FIG. 2). When the two are welded in place, lack of a flat point can cause sliding and the two cannot be welded in a perpendicular fashion; molds are required to hold each in place separately to be able to weld them together perpendicularly. In addition, welding is rendered uneasy because of the molds, creating welding difficulties and a complicated process.
2: Poor quality of welding results in easily breakable final products. Welding a curved surface to a flat surface requires the help of molds, but it is still difficult to weld the two perfectly in a perpendicular fashion; this often causes the angles between each chair leg-supporting framework (1) to be different. In this case, when it is used by a user, the weight supported by each chair leg-supporting framework (1) is different, and the ones taking on most weight could crack at the point of connection. Different angles and uneven weight bearing causes the finished product to be unbalanced; use results in wobbliness and other problems. In addition, the above connection welds a flat surface onto a curved surface, resulting in a small welded surface that is the size of the flat surface's circumference. This structure is insufficiently strong and the finished product cracks at the weld point. There will never be enough finished products to use because it is easily broken.
3: Lengthens the time of production and decreases efficiency. Because molds are required in the welding process, it is necessary to put both in place, and it must be put in place once for the welding of each set. This causes longer time of production and poor production efficiency.
4: Results in a finished product that is not aesthetically pleasing. Products currently on the market are increasingly more focused on aesthetic value. Chair leg structures of previous techniques are welded at the outer ring surface (12) of bushings; this results in obvious weld marks (14) at every welding point. This negatively affects the overall outer appearance of products, and does not satisfy current market product demands.

### MAJOR COMPONENTS

(1) Chair leg-supporting framework (2) Inner bushing
(3) Outer bushing (4) Chair leg-supporting framework
(11)Bushing (31) Round hole
(12)Outer ring surface (32) Inner ring surface
(13)Surface (33) Outer ring surface
(14)Weld mark (34) Bushing hole
(15)Rotating axle (35) Weld mark
(41)Point of insertion (5) Rotating axle
(42) Point of insertion

### SUMMARY

This creation is an improvement on a chair's legs. Basically, it opens several holes which have uniform distances and angles at appropriate locations on the outer bushing, holes with coordinated angles in the chair leg-supporting framework, insert the ends of the chair leg-supporting framework into the holes and fasten. Then weld the inner ring surface of the outer bushing and insert an inner bushing into an outer bushing. This achieves ease of the product's operation, durability, quality, efficiency, as well as high aesthetic value.

### BRIEF DESCRIPTION OF THE DRAWINGS

FIG. 1 is a three-dimensional structure diagram of conventional chair legs

FIG. 2 is a partial cross-section diagram of conventional chair legs

FIG. 3 is a three-dimensional diagram of this creation

FIG. 4 is a three-dimensional component diagram of this creation

FIG. 5 is a partial cross-section diagram of this creation

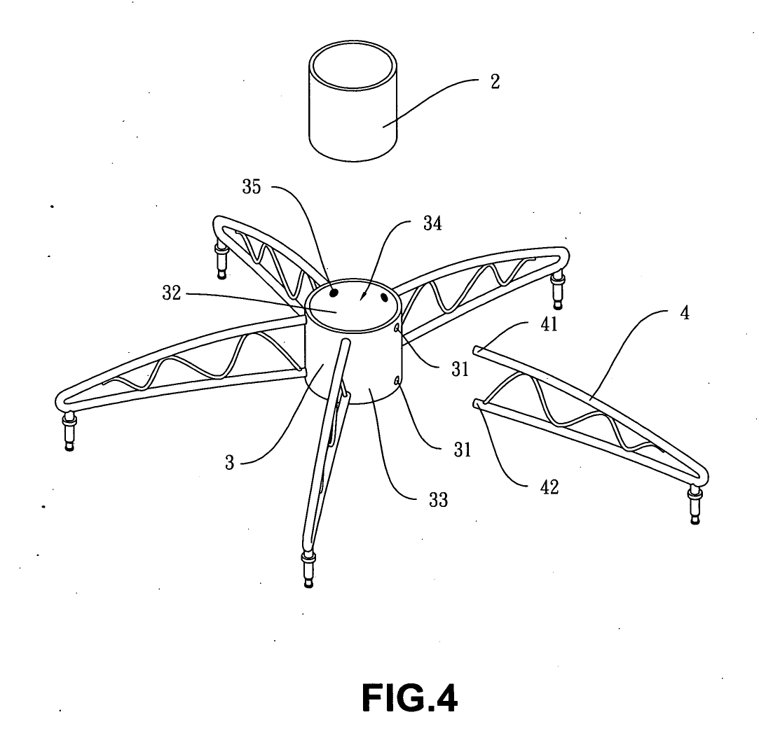

The specified representation diagram of this case is FIG. 4.

### DETAIL DESCRIPTION OF THE INVENTION

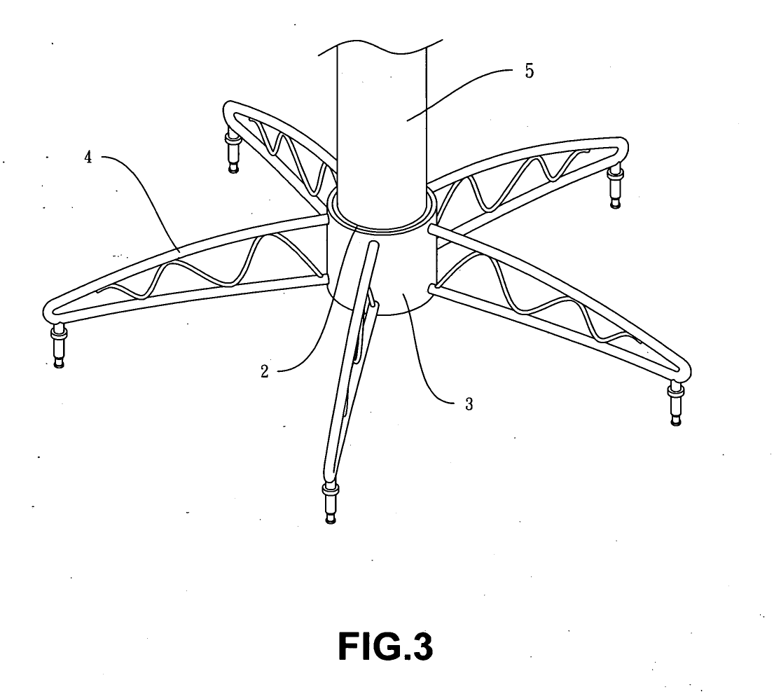

Please refer to FIG. 3 and FIG. 4, respectively the 3D diagram and 3D decomposition diagram of this creation. It can be seen that it is mainly formed by the inner bushing (2), outer bushing (3) and chair leg-supporting framework (4), and that in appropriate points on the circumference of the outer bushing (3), holes (31) that are opposite and equidistant are opened. These allow insertion points (41) and (42) of the chair leg-supporting framework (4) to be inserted. Thus, the two insertion points (41) 5 and (42) can be even against the inner surface (32) of the outer bushing (3) and can be welded into place. At the same time, the inner surface of the outer bushing (3) can hold an inner bushing (2) in place without falling loose, to let the axle turn.

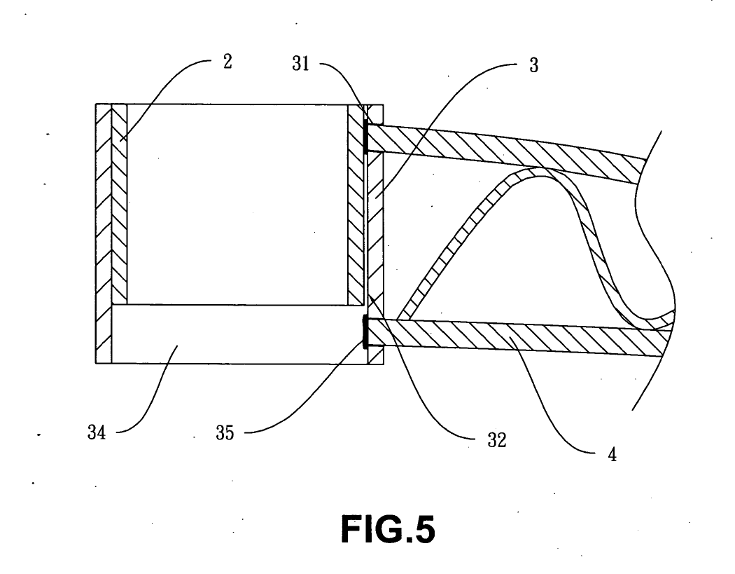

In the previously mentioned structure, the angle between the holes (31) is set according to the angle between the points of insertion (41) and (42). This allows the end surfaces of insertion points (41) and (42) to match the inner ring surface (32) (as shown in FIG. 5). Because the angles match, when chair leg-supporting framework (4) is fastened to it, it can form a tight fit that does not slide easily. The outer bushing (3) and the chair leg-supporting framework (4) are thus in place perpendicularly. This is complemented by the fact that the holes (31) have a uniform distance between them. When the chair leg-supporting framework (4) is inserted into the outer bushing (3), it can avoid framework (4) is inserted into the outer bushing (3), it can avoid the problems of uneven bearing, unbalance, and wobbling for the whole chair's chair leg structure.

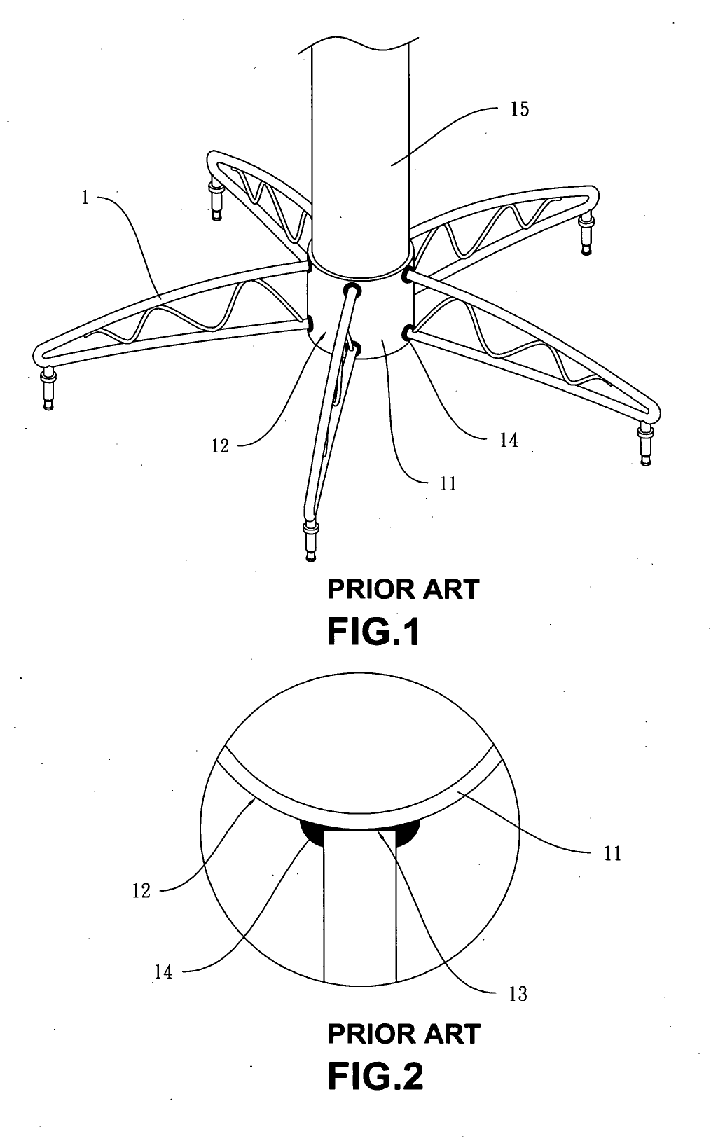

Further, in the aforementioned structure, the chair leg-supporting framework (4) and outer bushing (3) are connected by welding. However, previous technology directly welds chair leg-supporting framework (1) onto the outer ring surface (12) of the bushing (11), resulting in ugly weld marks (14) (as shown in FIG. 1), which affect the aesthetic value of the overall appearance of the finished product. In view of this, the creator studies and improves on this problem by inserting the chair leg-supporting framework (4) into holes (31), the welding at the inner ring surface (32) of the outer bushing (3). In this way, weld marks (35) occur on the inner ring surface (32) (as shown in FIG. 4); there are no weld marks (35) on the external appearance of the finished product. A beautified product would satisfy current market demands of products.

Moreover, previous invention welds the chair leg-supporting framework (1) directly on the outer ring surface only the size of the end surface's circumference (13). The use of such a product lacks stability and durability. If it is to support great weight, it could crack at the weld points. Therefore, the creator of this product studies and improves on this problem by inserting the points of insertion (41) and (42) into the holes (31), which would allow the entire chair leg-supporting framework (4) to have greater contact surface with the outer bushing (3) (as shown in FIG. 5). This also increases the welding surface; it would not crack regardless of the weight it has to support.

In addition, weld marks (35) produced by the above structure causes the inner ring surface (32) of the outer bushing (3) to be bumpy (as shown in FIG. 5), which in turn causes problems while inserting and fastening the inner bushing (2). Therefore, hydraulic machines are required to forcefully insert the outer bushing (3) into bushing holes (34) in order to create a chair leg structure that is established around a rotating axle (5) (as shown in FIG. 3).

However, the outer bushing (3) in this creation has holes (31), of which the number, angle, type; and type of chair leg-supporting framework (4) are not restricted. Primarily, the holes and chair leg-supporting framework can be matched and adjusted according to one another. In other words, the holes should be adjusted depending on the number of connections to the chair leg-supporting framework (4). In addition, if the chair leg-supporting framework (4) modifies the angle or type of insertion point, then the angles or types of holes (31) should also be modified. Therefore, the creator reserves the right to modify the angles or types of holes (31) and the chair leg-supporting framework (4), and modification does not affect, the improvement goals of this creation.

In summary of the above structure, this creation provides simple improvements of chair leg structure that indeed increase the product's usability, durability, quality, efficiency, and aesthetic value. Certainly, the industrial practicality, novelty, and inventiveness requirements of a patent have been fulfilled. In view of the aforementioned problems in chair leg structure, this creator researched ways to improve, and efforts resulted in this creation.

This creation primarily opens several holes that have uniform distances and angles at appropriate locations on the outer bushing, and opens holes with coordinated angles in the chair leg-supporting framework, insert the ends of the chair leg-supporting framework into the holes and fasten. Then weld the inner ring surface of the outer bushing and insert an inner bushing into an outer bushing. The merits of this invention are described as following.
1: Ease of welding. Because of previously drilled holes on the outer ring surface of the outer bushing that match the ends of the chair leg-supporting framework ends, each chair leg-supporting framework can be inserted into the holes and fastened into place for welding, resulting in the accurate welding of two perpendicular surfaces that do not slide, without the use of molds. In addition, because there are no molds, welding work is far smoother, resulting in overall ease of operation and simplicity of procedure.
2: It can achieve a better quality of welding and a more durable finished product. The slope of the holes on the outer bushing matches that of the ends of the chair leg-supporting framework, and there is uniformity in the angles and distances between them. Fastening the chair leg-supporting framework can achieve a perpendicular state between the two. The angles and distances of each chair leg-supporting framework are uniform, so the final structure would not bear uneven weight or be unbalanced. The final product does not break easily or wobble. In addition, the points are inserted into the outer bushing, creating greater contact surface between the whole chair leg-supporting framework and the outer bushing, which greatly increases the welding surface. The finished product would not break at the point of welding, increasing its durability.
3: The time of manufacture is decreased and increase the efficiency of manufacture. The angles and distances are uniform, and there is no need for molds during welding. Thus, welding can be easily completed, increasing the efficiency of production.
4: An aesthetically pleasing product is achieved, because the weld point is on the inner ring surface of the outer bushing; there are no weld marks on the overall outward appearance, this is in accordance with the current demands for beautiful products.

1. A type of chair leg structural improvement essentially formed by the inner bushing, outer bushing, and chair leg-supporting framework. It opens rows of opposing and equidistant holes at appropriate places on the circumference surface of the outer bushing to allow two points of insertion at ends of the chair leg-supporting framework to be inserted. The inserted ends can be even against the inner ring surface of the outer bushing, which is then welded into place. At the same time, an inner bushing can be inserted inside the outer bushing, which can stabilize without sliding off while allowing the axle cover to rotate. This is its main characteristic.
